(19) United States
(12) Patent Application Publication
(10) Pub. No.: US 2012/0200615 A1
(43) Pub. Date: Aug. 9, 2012

(54) LIQUID CRYSTAL DISPLAY DEVICE

(75) Inventor: Toshihide Tsubata, Osaka-shi (JP)

(73) Assignee: SHARP KABUSHIKI KAISHA, Osaka-shi, Osaka (JP)

(21) Appl. No.: 13/501,797

(22) PCT Filed: Oct. 20, 2010
(86) PCT No.: PCT/JP2010/068438

§ 371 Date: Apr. 13, 2012

(30) Foreign Application Priority Data
Oct. 22, 2009 (JP) 2009-243485

(51) Int. Cl. G09G 3/36; G09G 5/10

(52) U.S. Cl. 345/690; 345/89

(57) ABSTRACT

The liquid crystal display device (100) of this invention has pixels arranged in columns and rows to form a matrix pattern, and includes an active-matrix substrate (10), a counter substrate (20), a liquid crystal layer (30), a scan line driver (2) and a signal line driver (3). The pixels include m kinds of (where m is an even number and m≧4) pixels that display different colors. The signal lines (13) of the active-matrix substrate (10) include pairs of signal lines (13), each pair of which is provided for an associated column of pixels and which are first and second signal lines (13a, 13b) to which grayscale voltages of opposite polarities are supplied from the signal line driver (3). In two pixels that are adjacent in the column direction, the switching element (14) of one of the two pixels is connected to the first signal line (13a) and the switching element (14) of the other pixel is connected to the second signal line (13b). In two adjacent rows of pixels, their switching elements (14) have their ON and OFF states controlled using the same scan signal. The present invention improves the display quality of a liquid crystal display device of which each picture element is defined by an even number of pixels.

### TECHNICAL FIELD

The present invention relates to a liquid crystal display device and more particularly relates to a liquid crystal display device that conducts a display operation in colors by using four or more kinds of pixels that display mutually different colors.

### BACKGROUND ART

Liquid crystal display devices are currently used in a variety of applications. In a general liquid crystal display device, one picture element consists of three pixels respectively representing red, green and blue, which are the three primary colors of light, thereby conducting a display operation in colors.

A conventional liquid crystal display device, however, can reproduce colors that fall within only a narrow range (which is usually called a “color reproduction range”), which is a problem. Thus, to broaden the color reproduction range of liquid crystal display devices, a technique for increasing the number of primary colors for use to perform a display operation has recently been proposed.

For example, Patent Document No. 1 discloses a liquid crystal display device 800 in which one picture element P is made up of four pixels that include not only red, green and blue pixels R, G and B representing the colors red, green and blue, respectively, but also a yellow pixel Y representing the color yellow as shown in FIG. 11. That liquid crystal display device 800 performs a display operation in colors by mixing together the four primary colors red, green, blue and yellow that are represented by those four pixels R, G, B and Y.

By performing a display operation using four or more primary colors, the color reproduction range can be broadened compared to a conventional liquid crystal display device that uses only the three primary colors for display purposes. Such a liquid crystal display device that conducts a display operation using four or more primary colors will be referred to herein as a “multi-primary-color liquid crystal display device”. And a liquid crystal display device that conducts a display operation using the three primary colors will be referred to herein as a “three-primary-color liquid crystal display device”.

On the other hand, Patent Document No. 2 discloses a liquid crystal display device 900 in which one picture element P is made up of four pixels that include not only red, green and blue pixels R, G and B but also a white pixel W representing the color white as shown in FIG. 12. As the pixel added is a white pixel W, that liquid crystal display device 900 cannot broaden the color reproduction range but can still increase the display luminance.

However, if one picture element P is made up of an even number of pixels as in the liquid crystal display devices 800 and 900 shown in FIGS. 11 and 12, a so-called “horizontal shadow” phenomenon will arise and debase the display quality when a dot inversion drive operation is carried out. The dot inversion drive is a technique for minimizing the occurrence of a flicker on the display screen and is a driving method in which the polarity of the applied voltage is inverted on a pixel-by-pixel basis.

FIG. 13 shows the polarities of voltages applied to respective pixels when a dot inversion drive operation is carried out on a three-primary-color liquid crystal display device. On the other hand, FIGS. 14 and 15 show the polarities of voltages applied to respective pixels when a dot inversion drive operation is carried out on the liquid crystal display devices 800 and 900, respectively.

In a three-primary-color liquid crystal display device, the polarities of the voltages applied to pixels in the same color invert in the row direction as shown in FIG. 13. For example, in the first, third and fifth rows of pixels shown in FIG. 13, the voltages applied to the red pixels R go positive (+), negative (−) and positive (+) in this order from the left to the right. The voltages applied to the green pixels G go negative (−), positive (+) and negative (−) in this order. And the voltages applied to the blue pixels B go positive (+), negative (−) and positive (+) in this order.

In the liquid crystal display devices 800 and 900, on the other hand, each picture element P is made up of an even number of (i.e., four in this case) pixels. That is why in each and every row of pixels, the voltages applied to pixels in the same color have the same polarity everywhere as shown in FIGS. 14 and 15. For example, in the first, third and fifth rows of pixels shown in FIG. 14, the polarities of the voltages applied to every red pixel R and every yellow pixel Y are positive (+) and those of the voltages applied to every green pixel G and every blue pixel B are negative (−). Meanwhile, in the first, third and fifth rows of pixels shown in FIG. 15, the polarities of the voltages applied to every red pixel R and every blue pixel B are positive (+) and those of the voltages applied to every green pixel G and every white pixel W are negative (−).

If the voltages applied to pixels in the same color come to have the same polarity anywhere in the row direction in this manner, a horizontal shadow will be cast when a window pattern is displayed in a single color. Hereinafter, it will be described with reference to FIG. 16 why such a horizontal shadow is cast.

As shown in FIG. 16(a), when a high-luminance window WD is displayed on a low-luminance background BG, horizontal shadows SD, which have a higher luminance than the background to be displayed originally, are sometimes cast on the right- and left-hand sides of the window WD.

FIG. 16(b) illustrates an equivalent circuit of a portion of a normal liquid crystal display device that covers two pixels. As shown in FIG. 16(b), each of these pixels has a thin-film transistor (TFT) 14. A scan line 12, a signal line 13 and a pixel electrode 11 are respectively electrically connected to the gate, source and drain electrodes of the TFT 14.

A liquid crystal capacitor C_{LC} is formed by the pixel electrode 11, a counter electrode 21 that is arranged to face the pixel electrode 11, and a liquid crystal layer that is interposed between the pixel electrode 11 and the counter electrode 21. Meanwhile, a storage capacitor C_{CS} is formed by a storage capacitor electrode 17 that is electrically connected to the pixel electrode 11, a storage capacitor counter electrode 15a that is arranged to face the storage capacitor electrode 17, and a dielectric layer (i.e., an insulating film) interposed between the storage capacitor electrode 17 and the storage capacitor counter electrode 15a.

The storage capacitor counter electrode 15a is electrically connected to a storage capacitor line 15 and supplied with a storage capacitor counter voltage (CS voltage). FIGS. 16(c) and 16(d) show how the CS voltage and the gate voltage change with time. It should be noted that write voltages (i.e., grayscale voltages applied to the pixel electrode 11 through the signal line 13) have mutually different polarities in FIGS. 16(c) and 16(d).

When the gate voltage goes high to start charging a pixel, the potential of the pixel electrode 11 (i.e., its drain voltage) changes. In the meantime, a ripple voltage is superposed on the CS voltage by way of a parasitic capacitor between the drain and the CS as shown in FIGS. 16(c) and 16(d). As can be seen by comparing FIGS. 16(c) and 16(d), the polarity of the ripple voltage inverts according to that of the write voltage.

The ripple voltage superposed on the CS voltage attenuates with time. If the write voltage has small amplitude (i.e., when the write voltage is applied to pixels that display the background BG), the ripple voltage goes substantially zero when the gate voltage goes low. On the other hand, if the write voltage has large amplitude (i.e., when the write voltage is applied to pixels that display the window WD), the ripple voltage becomes relatively high compared to those pixels that display the background BG. As a result, as shown in FIGS. 16(c) and 16(d), even when the gate voltage goes low, the ripple voltage superposed on the CS voltage has not quite attenuated yet. That is to say, even after the gate voltage has gone low, the ripple voltage continues to attenuate. Consequently, due to that residual ripple voltage V α, the drain voltage (i.e., the pixel electrode potential) affected by the CS voltage varies from its original level.

On the same row of pixels, two ripple voltages of opposite polarities work to cancel each other, but two ripple voltages of the same polarity will superpose one upon the other. That is why if the voltages applied to pixels in the same color come to have the same polarity everywhere in the row direction as shown in FIGS. 14 and 15, horizontal shadows will be cast when a window pattern is displayed in a single color.

Patent Document No. 3 discloses a technique for avoiding casting such horizontal shadows. FIG. 17 illustrates a liquid crystal display device 1000 as disclosed in Patent Document No. 3.

As shown in FIG. 17, the liquid crystal display device 1000 includes an LCD panel 1001, including a plurality of picture elements P each consisting of red, green, blue and white pixels R, G, B and W, and a source driver 1003 that supplies a display signal to multiple signal lines 1013 of the LCD panel 1001.

The source driver 1003 includes a plurality of individual drivers 1003a, each of which is connected to an associated one of the signal lines 1013. Those individual drivers 1003a are arranged side by side in the row direction and output either a positive or negative grayscale voltage.

In a general source driver, the grayscale voltages output from each and every pair of adjacent individual drivers always have opposite polarities. That is to say, in a horizontal scanning period, the polarities of the grayscale voltages output from the source driver never fail to invert in the row direction in the order of positive, negative, positive, negative and so on.

On the other hand, in the source driver 1003 of the liquid crystal display device 1000, the grayscale voltages output from each pair of adjacent individual drivers 1003a do not always have opposite polarities. That is to say, the polarities of the grayscale voltages output from the source driver 1003 in one horizontal scanning period basically invert in the row direction, but sometimes voltages of the same polarity (i.e., positive and positive voltages or negative and negative voltages) may be output back to back.

Specifically, if those individual drivers 1003a are classified into multiple groups of individual drivers 1003G, each consisting of four consecutive drivers, grayscale voltages of mutually opposite polarities are output from two arbitrary individual drivers 1003a that are adjacent to each other in each group of drivers 1003G. And the polarity of the grayscale voltage output from an s^{th} individual driver 1003a (where s is naturally an integer that falls within the range of one to four) in an odd-numbered group of individual drivers 1003G is opposite to that of the grayscale voltage output from the s^{th} individual driver 1003a in an even-numbered group of individual drivers 1003G. Consequently, in each group 1003G of individual drivers, the grayscale voltages output from the individual drivers 1003a have either polarities that invert in the row direction or the same polarity back to back at the boundary between multiple groups 1003G of individual drivers.

In the liquid crystal display device 1000 with such an arrangement, grayscale voltages of mutually opposite polarities are applied to the respective pixel electrodes of two pixels that are adjacent to each other in the row direction in each picture element P, and grayscale voltages of mutually opposite polarities are applied to the respective pixel electrodes of two pixels that display the same color and that belong to two picture elements P that are adjacent to each other in the row direction. Consequently, the voltages applied to those pixels that are arranged in the row direction to display the same color do not have the same polarity, thus avoiding casting such horizontal shadows.

### CITATION LIST

### Patent Literature

Patent Document No. 1: PCT International Application Japanese National Phase Publication No. 2004-529396

Patent Document No. 2: Japanese Patent Application Laid-Open Publication No. 11-295717

Patent Document No. 3: PCT International Application Publication No. 2007/063620

### SUMMARY OF INVENTION

### Technical Problem

If the technique disclosed in Patent Document No. 3 is adopted, however, particular pixels will be interposed between two signal lines 1013 that apply grayscale voltages of the same polarity. In the arrangement shown in FIG. 17, blue pixels B are located between a signal line 1013 associated with their own pixel electrodes and a signal line 1013 associated with the pixel electrodes of their adjacent white pixels W, and the grayscale voltages supplied through these two signal lines 1013 have the same polarity. Consequently, those pixels located between the two signal lines 1013 that supply the voltages of the same polarity come to have display luminances that are no longer the original levels. As a result, the display quality will decline. The reason will be described below with reference to FIG. 18.

As shown in FIG. 18(a), when a display signal (i.e., a source signal) supplied to a signal line 1013 after a pixel has been charged changes, the potential at its pixel electrode (i.e., a drain voltage) also varies by way of the parasitic capacitance between the source and the drain (i.e., a source-drain capacitance Csd). In that case, the magnitude Δ V of the variation can be calculated by the following Equation (1) using the magnitude of variation (i.e., amplitude) Vspp of the source signal, the source-drain capacitance Csd and the pixel capacitance Cpix:

ΔV=Vspp·(Csd/Cpix) (1)

In general, the potential at the pixel electrode of a certain pixel is affected by not only a variation in voltage on the signal line 1013 that supplies a grayscale voltage to the pixel electrode of that pixel (and that will be sometimes referred to herein as “its own source”) but also by a variation in voltage on the signal line 1013 that supplies a grayscale voltage to the pixel electrode of a pixel that is adjacent to the former pixel in the row direction (and that will be sometimes referred to herein as “others' source”). For that reason, if the polarities of its own source signal and others' source signal are opposite to each other as shown in FIG. 18(b), the variation Δ V in potential at the pixel electrode is canceled.

In the conventional liquid crystal display device 1000 shown in FIG. 17, however, since its own source signal and others' source signal have the same polarity in each of the pixels that are located between two signal lines that supply voltages of the same polarity, ΔV is not canceled. As a result, the drain voltage decreases by Δ V and the effective voltage applied to the liquid crystal layer decreases, too. Consequently, the display luminance varies from the original level, and the image on the screen darkens and the display quality gets debased in the normally black mode. Such a decline in display quality is recognized as lines of display unevenness that run in the column direction (and that are called “vertical shadows”).

It is therefore an object of the present invention to improve the display quality of such a liquid crystal display device of which each picture element is defined by an even number of pixels.

### Solution to Problem

A liquid crystal display device according to the present invention has a plurality of pixels, which are arranged in columns and rows to form a matrix pattern. The device includes: an active-matrix substrate that includes pixel electrodes, each of which is provided for an associated one of the pixels, switching elements that are connected to the pixel electrodes, a plurality of scan lines that run in a row direction, and a plurality of signal lines that run in a column direction; a counter substrate that faces the active-matrix substrate; a liquid crystal layer that is interposed between the active-matrix substrate and the counter substrate; a scan line driver that supplies a scan signal to each said scan line; and a signal line driver that supplies a positive or negative grayscale voltage as a display signal to each said signal line. Those pixels include m kinds of (where m is an even number that is equal to or greater than four) pixels that display mutually different colors. The signal lines include multiple pairs of signal lines, each pair of which is provided for an associated column of pixels. Each pair of signal lines are first and second signal lines to which grayscale voltages of opposite polarities are supplied from the signal line driver. In two of those pixels that are adjacent to each other in the column direction, the switching element of one of the two pixels is connected to the first signal line and the switching element of the other pixel is connected to the second signal line. And in two adjacent rows of pixels of those pixels, their switching elements have their ON and OFF states controlled using the same scan signal.

In one preferred embodiment, four of those signal lines, which are associated with two adjacent columns of pixels, are arranged so that the first signal line provided for one of two columns of pixels is adjacent to the second signal line provided for the other column of pixels.

In one preferred embodiment, four of those signal lines, which are associated with two adjacent columns of pixels, are arranged so that either the respective first signal lines or the respective second signal lines are adjacent to each other.

In one preferred embodiment, the pixels are arranged so that the m kinds of pixels are repeatedly arranged in the same order in the row direction.

In one preferred embodiment, the liquid crystal display device of the present invention includes a plurality of picture elements, each of which is defined by m pixels that are arranged consecutively in the row direction. In each of those picture elements, grayscale voltages of opposite polarities are applied to the pixel electrodes of two adjacent pixels. In two arbitrary ones of those picture elements that are adjacent to each other in the row direction, grayscale voltages of mutually opposite polarities are applied to the pixel electrodes of pixels that display the same color.

In one preferred embodiment, the pixels include red, green and blue pixels representing the colors red, green and blue, respectively.

In one preferred embodiment, the pixels further include yellow pixels representing the color yellow.

In one preferred embodiment, the pixels further include white pixels representing the color white.

In one preferred embodiment, the pixels further include cyan, magenta and yellow pixels representing the colors cyan, magenta and yellow, respectively.

In one preferred embodiment, the device has a vertical scanning frequency of 120 Hz or more.

### Advantageous Effects of Invention

The present invention improves the display quality of a liquid crystal display device, of which each picture element is defined by an even number of pixels.

### BRIEF DESCRIPTION OF DRAWINGS

FIG. 1 illustrates a liquid crystal display device 100 as a preferred embodiment of the present invention.

FIG. 2 is a plan view schematically illustrating a region of the liquid crystal display device 100 according to a preferred embodiment of the present invention that is allocated to eight pixels arranged in four columns and two rows (i.e., two picture elements P that are adjacent to each other in the column direction).

FIG. 3 is a cross-sectional view schematically illustrating the liquid crystal display device 100 according to a preferred embodiment of the present invention as viewed on the plane 3A-3A′ shown in FIG. 2.

FIG. 4 schematically illustrates a liquid crystal display device 100 as a preferred embodiment of the present invention.

FIG. 5 schematically illustrates a liquid crystal display device 100 as a preferred embodiment of the present invention.

FIG. 6 schematically illustrates a liquid crystal display device 100 as a preferred embodiment of the present invention.

FIG. 7 is a plan view schematically illustrating a region of a liquid crystal display device 200 as a preferred embodiment of the present invention that is allocated to eight pixels arranged in four columns and two rows (i.e., two picture elements P that are adjacent to each other in the column direction).

FIG. 8 schematically illustrates a liquid crystal display device 200 as a preferred embodiment of the present invention.

FIG. 9 illustrates an alternative LCD panel 1 that may be used in the liquid crystal display device 100 (or 200) according to a preferred embodiment of the present invention.

FIG. 10 illustrates another alternative LCD panel 1 that may be used in the liquid crystal display device 100 (or 200) according to a preferred embodiment of the present invention.

FIG. 11 schematically illustrates a conventional liquid crystal display device 800.

FIG. 12 schematically illustrates another conventional liquid crystal display device 900.

FIG. 13 shows the polarities of voltages applied to respective pixels when a dot inversion drive operation is carried out on a three-primary-color liquid crystal display device.

FIG. 14 shows the polarities of voltages applied to respective pixels when a dot inversion drive operation is carried out on the conventional liquid crystal display device 800.

FIG. 15 shows the polarities of voltages applied to respective pixels when a dot inversion drive operation is carried out on the conventional liquid crystal display device 900.

FIGS. 16(a) to 16(d) show how horizontal shadows are cast.

FIG. 17 schematically illustrates still another conventional liquid crystal display device 1000.

FIGS. 18(a) and 18(b) show why the display quality is debased in a conventional liquid crystal display device 1000.

### DESCRIPTION OF EMBODIMENTS

Hereinafter, preferred embodiments of the present invention will be described with reference to the accompanying drawings. It should be noted, however, that the present invention is in no way limited to the preferred embodiments to be described below.

### Embodiment 1

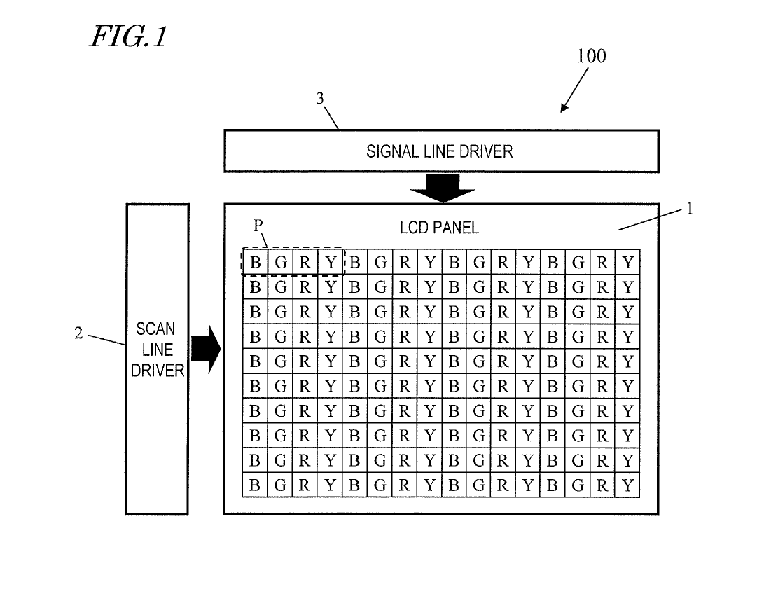

FIG. 1 illustrates a liquid crystal display device 100 as a first specific preferred embodiment of the present invention. As shown in FIG. 1, the liquid crystal display device 100 includes an LCD panel 1 with a plurality of pixels that are arranged in columns and rows to form a matrix pattern, and a scan line driver (or gate driver) 2 and a signal line driver (or source driver) 3 that supply drive signals to the LCD panel 1.

The pixels of the LCD panel 1 include red, green, blue, and yellow pixels R, G, B and Y representing the colors red, green, blue, and yellow, respectively. That is to say, the pixels include four kinds of pixels that represent mutually different colors.

Those pixels are arranged so that the four kinds of pixels are repeatedly arranged in the same order in the row direction. Specifically, in the example illustrated in FIG. 1, those pixels are arranged recursively in the order of blue, green, red and yellow pixels B, G, R and Y from the left to the right.

One picture element P, which is the minimum unit to conduct a display operation in colors, is formed by a set of four pixels that are arranged consecutively in the row direction. In the example illustrated in FIG. 1, in each picture element P, the four kinds of pixels are arranged in the order of blue, green, red and yellow pixels B, G, R and Y from the left to the right.

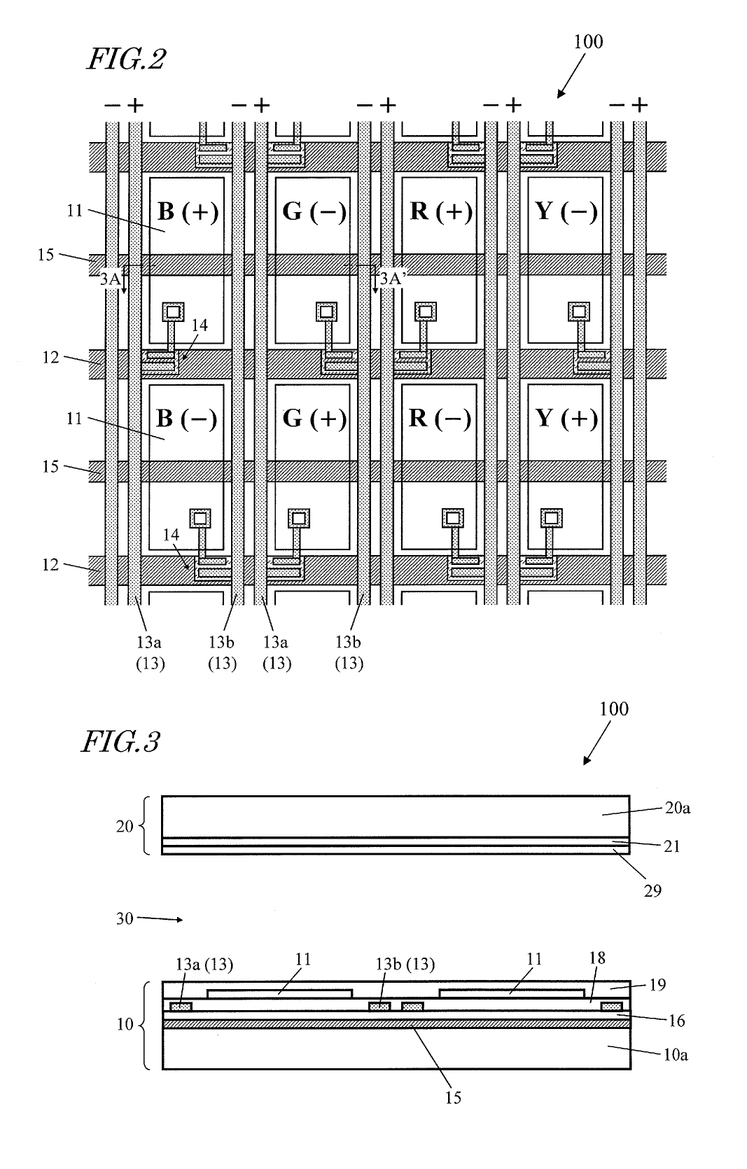

FIGS. 2 and 3 illustrate a specific structure for the LCD panel 1. Specifically, FIG. 2 is a plan view illustrating a region of the LCD panel 1 that is allocated to eight pixels arranged in four columns and two rows (i.e., two picture elements P that are adjacent to each other in the column direction). FIG. 3 illustrates a portion of the LCD panel 1 corresponding to two pixels that are adjacent to each other in the row direction and is a cross-sectional view as viewed on the plane 3A-3A′ shown in FIG. 2.

The LCD panel 1 includes an active-matrix substrate 10, a counter substrate 20 that faces the active-matrix substrate 10, and a liquid crystal layer 30 that is interposed between the active-matrix substrate 10 and the counter substrate 20.

The active-matrix substrate 10 includes pixel electrodes 11, each of which is provided for an associated one of the pixels, thin-film transistors (TFTs) 14 connected to the pixel electrodes 11, a plurality of scan lines 12 that run in the row direction, and a plurality of signal lines 13 that run in the column direction. Each TFT 14 functioning as a switching element is supplied with not only a scan signal from its associated scan line 12 but also a display signal from its associated signal line 13.

The scan lines 12 are arranged on a transparent substrate (e. a glass substrate) 10a with electrically insulating properties. On the transparent substrate 10a, also arranged is a storage capacitor line 15 that runs in the row direction. The storage capacitor line 15 and the scan lines 12 are made of the same conductor film. The storage capacitor line 15 is supplied with a storage capacitor counter voltage (CS voltage).

A gate insulating film 16 is arranged to cover the scan lines 12 and the storage capacitor lines 15. On the gate insulating film 16, arranged are the signal lines 13. An interlayer insulating film 18 is arranged to cover the signal lines 13. The pixel electrodes 11 are located on the interlayer insulating film 18.

The counter substrate 20 includes a counter electrode 21, which faces the pixel electrodes 11 and which is arranged on a transparent substrate (such as a glass substrate) 20a with electrically insulating properties. Although not shown in any of the drawings, the counter substrate 20 typically further includes a color filter layer and an opaque layer (i.e., a black matrix). The color filter layer includes red, green, blue, and yellow color filters that transmit red, green, blue, and yellow rays, respectively, and that are associated with the red, green, blue, and yellow pixels R, G, B and Y, respectively. And the opaque layer is arranged between those color filters.

Alignment films 19 and 29 are arranged on the respective uppermost surfaces of the active-matrix substrate 10 and the counter substrate 20 to contact with the liquid crystal layer 30. As the alignment films 19 and 29, either horizontal alignment films or vertical alignment films are provided according to the mode of display to take.

The liquid crystal layer 30 includes liquid crystal molecules that have either positive or negative dielectric anisotropy depending on the mode of display, and a chiral agent as needed.

In the LCD panel 1 with such a structure, a liquid crystal capacitor C_{LC} is formed by the pixel electrode 11, the counter electrode 21 that faces the pixel electrode 11, and the liquid crystal layer 30 interposed between them. Also, a storage capacitor C_{CS} is formed by the pixel electrode 11, the storage capacitor line 15, and the gate insulating film 16 and interlayer insulating film 18 interposed between them. And a pixel capacitor Cpix is formed by the liquid crystal capacitor C_{LC} and the storage capacitor C_{CS} that is arranged in parallel to the liquid crystal capacitor C_{LC}. It should be noted that the storage capacitor C_{CS} does not have to have this configuration. For example, the storage capacitor C_{CS} may also be formed by a storage capacitor electrode that is made of the same conductor film as the signal lines 13, the storage capacitor line 15, and the gate insulating film 16 interposed between them.

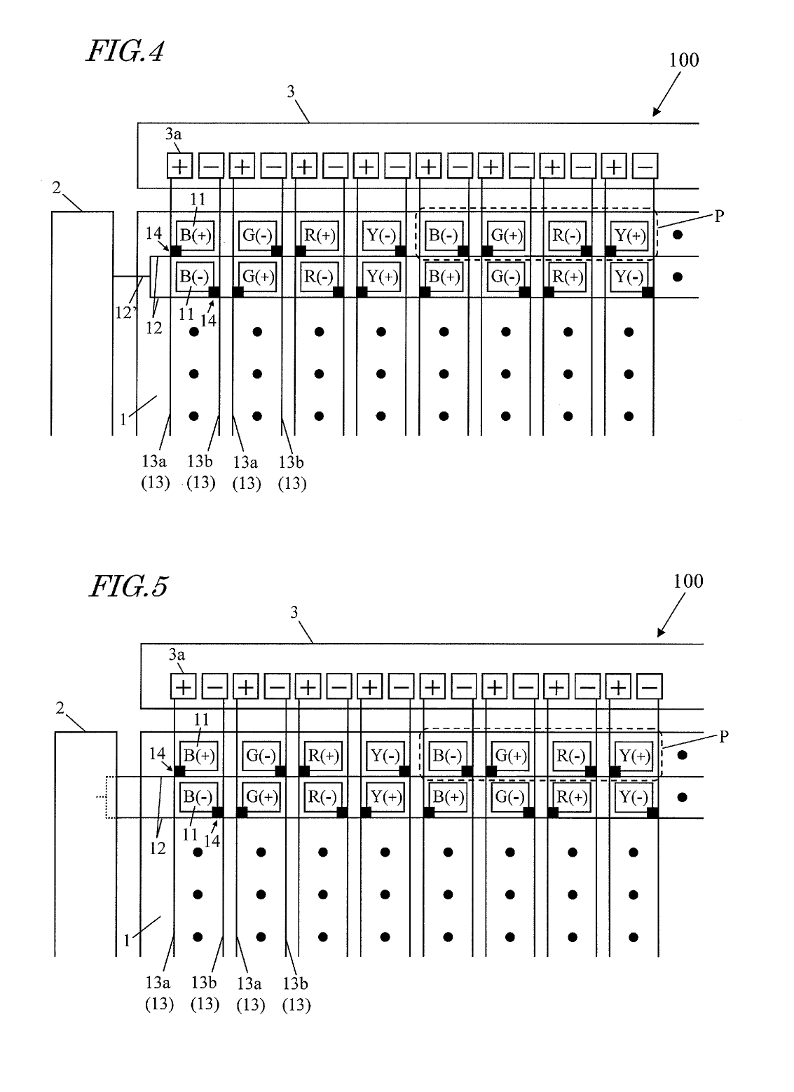

Hereinafter, the configuration of the liquid crystal display device 100 will be described in further detail with reference to FIG. 4, which illustrates how the scan line driver 2, the signal line driver 3 and the LCD panel 1 are connected together.

The scan line driver 2 supplies a scan signal to each of the multiple scan lines 12 of the LCD panel 1. On the other hand, the signal line driver 3 supplies a display signal to each of the multiple signal lines 13 of the LCD panel 1. As shown in FIG. 4, the signal line driver 3 includes a plurality of output terminals 3a that are arranged in the row direction. Each of those output terminals 3a is connected one to one to an associated one of the signal lines 13. A positive or negative grayscale voltage is output through each of the output terminals 3a. That is why the signal line driver 3 supplies a positive or negative grayscale voltage as the display signal to each of the multiple signal lines 13.

The polarities of the grayscale voltages are determined by reference to the voltage applied to the counter electrode 21 (which will be referred to herein as a “counter voltage”). In FIGS. 2 and 4, the polarities of the grayscale voltages to be output through the output terminals 3a of the signal line driver 3 (and supplied to the signal lines 13) and those of the grayscale voltages applied to the pixel electrodes 11 through the signal lines 13 and the TFTs 14 in one vertical scanning period are indicated by “+” and “−”.

In a general liquid crystal display device, a signal line is provided for each column of pixels. In the liquid crystal display device 100 of this preferred embodiment, on the other hand, two signal lines 13 are provided for each column of pixels as shown in FIGS. 2 and 4. In the following description, one 13a of the two signal lines that are provided for each column of pixels will be sometimes referred to herein as a “first signal line” and the other 13b as a “second signal line”, respectively. The first and second signal lines 13a and 13b are supplied with grayscale voltages of opposite polarities by the signal line driver 3. In the vertical scanning period shown in FIG. 4, positive and negative grayscale voltages are supplied to the first and second signal lines 13a and 13b, respectively. To the contrary, in the next vertical scanning period, negative and positive grayscale voltages are supplied to the first and second signal lines 13a and 13b, respectively.

With respect to each column of pixels, the first signal line 13a is arranged on the left-hand side of the pixel electrodes 11 and the second signal line 13b is arranged on the right-hand side of the pixel electrodes 11. Thus the signal lines 13 are arranged so that the multiple pairs of first and second signal lines 13a and 13b alternate with each other in the row direction. That is to say, when attention is paid to four signal lines 13 that are associated with two adjacent columns of pixels, those four signal lines 13 are arranged so that the first signal line 13a of one column of pixels is adjacent to the second signal line 13b of the other column of pixels.

Also, as shown in FIGS. 2 and 4, one of the two TFTs 14 of any two pixels that are adjacent to each other in the column direction is connected to the first signal line 13a, while the other TFT 14 is connected to the second signal line 13b. Taking the two blue pixels B shown in FIG. 2 as an example, it can be seen that the upper blue pixel B has its TFT 14 connected to the first signal line 13a but the lower blue pixel B has its TFT 14 connected to the second signal line 13b. In this manner, pixels, of which the TFT 14 is connected to the first signal line 13a (and which will be referred to herein as a “first type of pixels”) and pixels, of which the TFT 14 is connected to the second signal line 13b (and which will be referred to herein as a “second type of pixels”), are arranged alternately in the column direction.

In the row direction, basically, the first and second types of pixels are also arranged alternately but the first type of pixels (or the second type of pixels) appear consecutively in some regions. More specifically, although the first and second types of pixels are arranged alternately within each picture element P, the first (or second) type of pixels are arranged consecutively at the boundary between two picture elements P that are adjacent to each other in the row direction. Look at the four picture elements P shown in FIG. 4, for example, and it can be seen that pixels, of which the TFT 14 is connected to the first signal line 13a, and pixels, of which the TFT 14 is connected to the second signal line 13b, are arranged alternately within each of the four picture elements P. However, at the boundary between the upper left and upper right picture elements P, both of the yellow and blue pixels Y and B have their TFT 14 connected to the second signal line 13b (i.e., the same type of pixels appear back to back). Likewise, at the boundary between the lower left and lower right picture elements P, both of the yellow and blue pixels Y and B have their TFT 14 connected to the first signal line 13a (i.e., the same type of pixels appear in a row).

As also shown in FIG. 4, each pair of scan lines 12 are connected together outside of the display area (i.e., an area in which a number of pixels are arranged and which contributes to the display operation) and are further connected to the scan line driver 2 through a common signal line 12′. That is why the TFTs 14 of two adjacent rows of pixels have their ON and OFF states controlled with the same scan signal. That is to say, two rows of pixels can be selected at a time in one horizontal scanning period.

In this liquid crystal display device 100, as the TFTs 14 of those pixels are connected to the scan lines 12 and the signal lines 13 as described above, grayscale voltages of opposite polarities are applied to the respective pixel electrodes 11 of two pixels that are adjacent to each other in each picture element P. Likewise, grayscale voltages of opposite polarities are also applied to the respective pixel electrodes 11 of two pixels that are adjacent to each other in the column direction. In this manner, in this liquid crystal display device 100, the polarity of the grayscale voltage applied inverts one pixel after another not only in the column direction but also in the row direction (within each picture element P) as well. That is to say, the liquid crystal display device 100 performs an inversion drive that is similar to a dot inversion drive, thus minimizing the occurrence of flicker.

Furthermore, in the liquid crystal display device 100, grayscale voltages of mutually opposite polarities are applied to the respective pixel electrodes 11 of two pixels that display the same color and that belong to two picture elements P that are adjacent to each other in the row direction. In FIG. 4, for example, a positive grayscale voltage is applied to the respective pixel electrodes 11 of the blue and red pixels B and R in the upper left picture element P, but a negative grayscale voltage is applied to the respective pixel electrodes 11 of the blue and red pixels B and R in the upper right picture element P. Likewise, a negative grayscale voltage is applied to the respective pixel electrodes 11 of the green and yellow pixels G and Y in the upper left picture element P, but a positive grayscale voltage is applied to the respective pixel electrodes 11 of the green and yellow pixels G and Y in the upper right picture element P. Consequently, the voltages applied to those pixels that are arranged in the row direction to display the same color do not have the same polarity, thus avoiding casting horizontal shadows.

Furthermore, in the liquid crystal display device 100, two signal lines 13a and 13b are provided for each column of pixels and grayscale voltages of opposite polarities are supplied to those signal lines 13a and 13b. Consequently, the pixel electrode 11 of each and every pixel is always interposed between the two signal lines 13a and 13b that supply voltages of opposite polarities. That is why the variation Av (represented by Equation (1)) in drain voltage via the source-drain capacitance Csd after the pixels have been charged (i.e., the potential at the pixel electrode 11) is canceled, and therefore, a shift from the original level of the display luminance can be reduced significantly. As a result, it is possible to avoid casting vertical shadows and the display quality improves.

What is more, in this liquid crystal display device 100, the TFTs 14 of two adjacent rows of pixels have their ON and OFF states controlled with the common scan signal, and therefore, a write operation (i.e., charging) on pixels is carried out on a two-pixel-row basis. That is why compared to an ordinary liquid crystal display device that performs a write operation on one row of pixels after another, one horizontal scanning period can be extended and the pixels can be charged for a longer period of time.

Recently, people proposed that the driving rate be doubled in order to reduce the impression of image persistence when a moving picture is displayed. Specifically, they proposed that the vertical scanning frequency be increased from a normal value of 60 Hz to either 120 Hz (2×) or 240 Hz (4×). The liquid crystal display device 100 of this preferred embodiment can charge pixels for a sufficiently long time, and therefore, can carry out such a dual-speed drive operation (i.e., a drive operation at a vertical scanning frequency of 120 Hz or more).

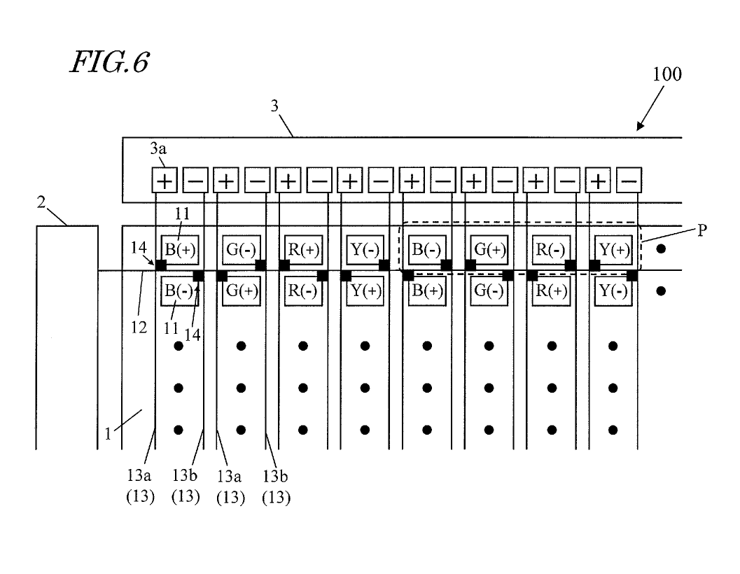

In the example illustrated in FIG. 4, two adjacent scan lines 12 are supposed to be connected together in the LCD panel 1 (i.e., in the active-matrix substrate 10). However, the present invention is in no way limited to that specific preferred embodiment. Rather any other configuration may be adopted as well as long as the TFTs 14 of two adjacent rows of pixels can have their ON and OFF states controlled with a common scan signal. For example, two adjacent scan lines 12 may be connected in the scan line driver 2, not inside the LCD panel 1, as shown in FIG. 5. Alternatively, a scan line 12 may be provided for every two rows of pixels and the respective TFTs 14 of those two rows of pixels may be connected to the same scan line 12 as shown in FIG. 6.

### Embodiment 2

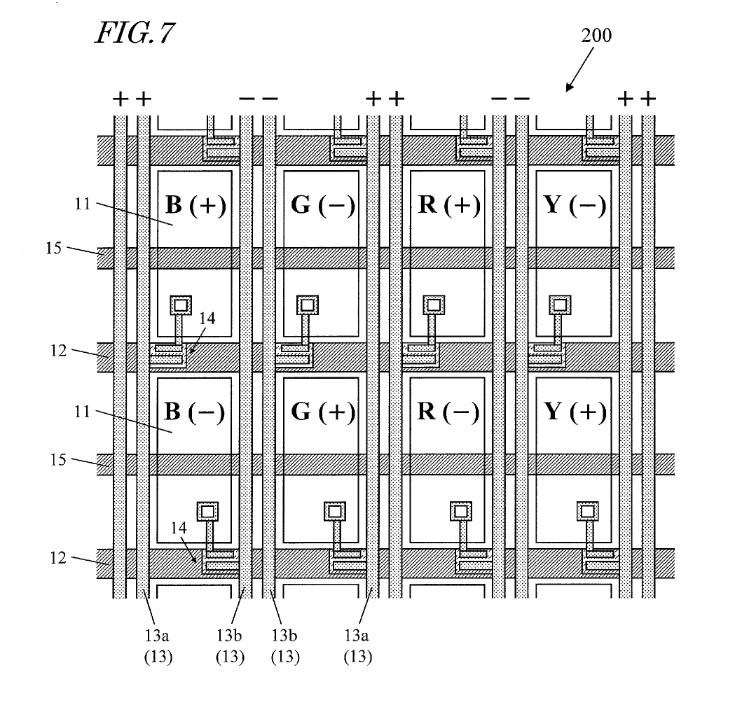

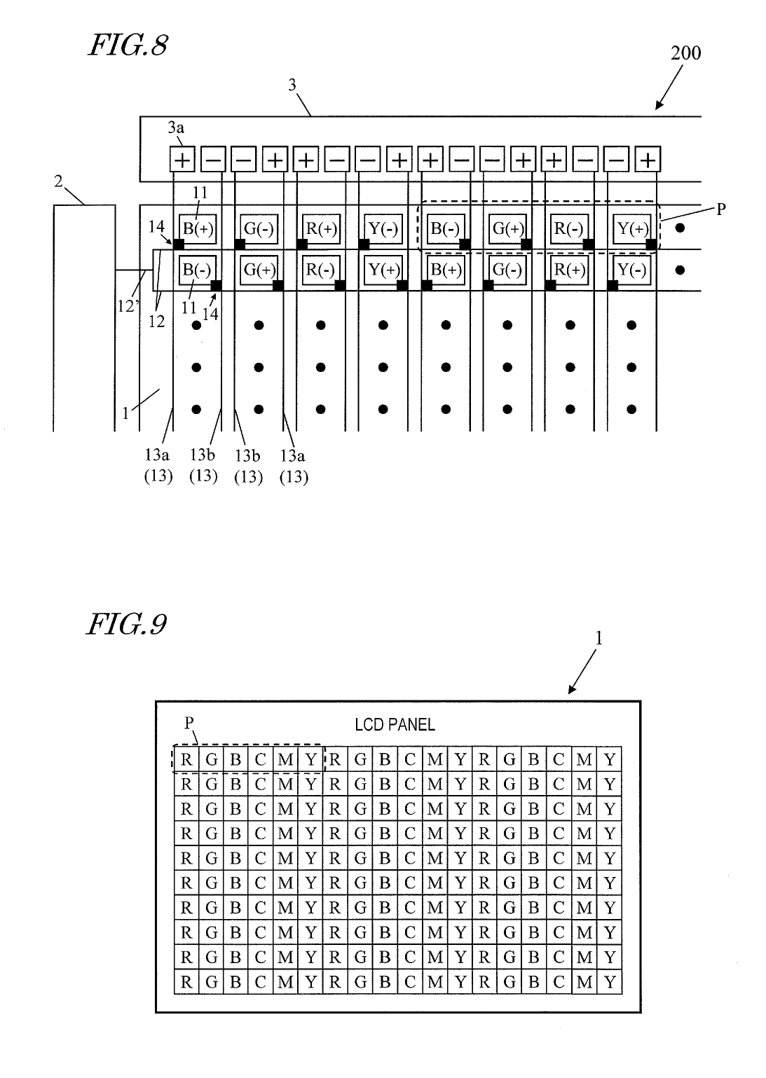

Hereinafter, a liquid crystal display device 200 as a second specific preferred embodiment of the present invention will be described with reference to FIGS. 7 and 8. The following description of this second preferred embodiment will be focused on the differences of the liquid crystal display device 200 from the counterpart 100 of the first preferred embodiment.

In the liquid crystal display device 100 of the first preferred embodiment described above, four signal lines associated with two adjacent columns of pixels are arranged so that the first signal line 13a of one of the two columns of pixels is adjacent to the second signal line 13b of the other column of pixels. That is to say, grayscale voltages of opposite polarities are supplied to two signal lines 13 that are adjacent to each other with no pixels (or pixel electrodes 11) interposed between them.

On the other hand, in the liquid crystal display device 200 of this second preferred embodiment, four signal lines 13 associated with two adjacent columns of pixels are arranged so that either the respective first signal lines 13a or second signal lines 13b are adjacent to each other as shown in FIGS. 7 and 8. That is to say, grayscale voltages of the same polarity are supplied to two signal lines 13 that are adjacent to each other with no pixels (or pixel electrodes 11) interposed between them.

In this manner, in the liquid crystal display device 200, grayscale voltages of the same polarity are supplied to two adjacent signal lines 13 with no pixels interposed between them (i.e., two closest signal lines 13). That is why the power to be dissipated due to the presence of a parasitic capacitance between those two signal lines 13 can be cut down and the load imposed on the signal line driver (source driver) 3 can be lightened.

On the other hand, according to the arrangement adopted in the liquid crystal display device 100 of the first preferred embodiment in which grayscale voltages of opposite polarities are supplied to two adjacent signal lines 13 with no pixels interposed between them (i.e., two closest signal lines 13), the development and manufacturing costs can be cut down, which is also beneficial. With such an arrangement adopted, the polarities of the grayscale voltages output from the signal line driver (source driver) 3 has the same alternating pattern (in which positive and negative signs alternate with each other) as a general-purpose dot inversion source driver as shown in FIG. 4. That is why a general-purpose controller for use in a dot inversion drive may be used as the controller that sends a control signal to the signal line driver 3.

In the preferred embodiments described above, four kinds of pixels are supposed to be arranged in each picture element P in the order of blue, green, red and yellow pixels B, G, R and Y from the left to the right in the drawings. However, the present invention is in no way limited to those specific preferred embodiments. The four kinds of pixels may also be arranged in any of various other patterns in each picture element P.

In the foregoing description, a single picture element P is supposed to be made up of four kinds of pixels as an example. However, this is just an example of the present invention. Rather, the present invention is broadly applicable for use in a liquid crystal display device in which each picture element P is defined by m different kinds of (where m is an even number that is equal to or greater than four) pixels that display mutually different colors. For example, each picture element P may be defined by six kinds of pixels as in the LCD panel 1 shown in FIG. 9. In the arrangement illustrated in FIG. 9, each picture element P includes not only red, green, blue, and yellow pixels R, G, B and Y but also cyan and magenta pixels C and M representing the colors cyan and magenta.

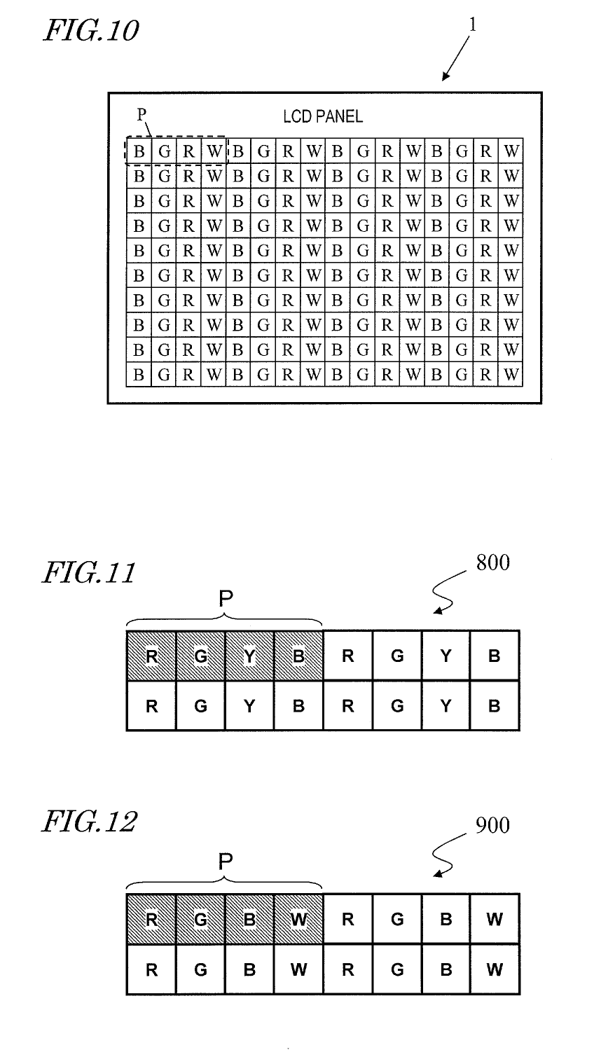

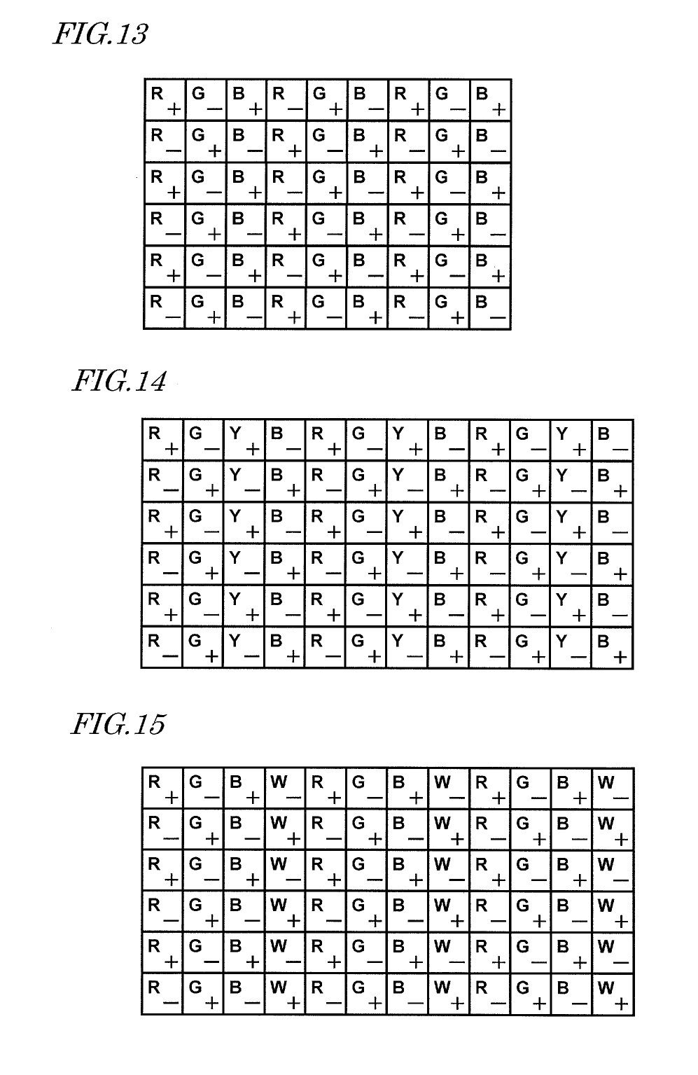

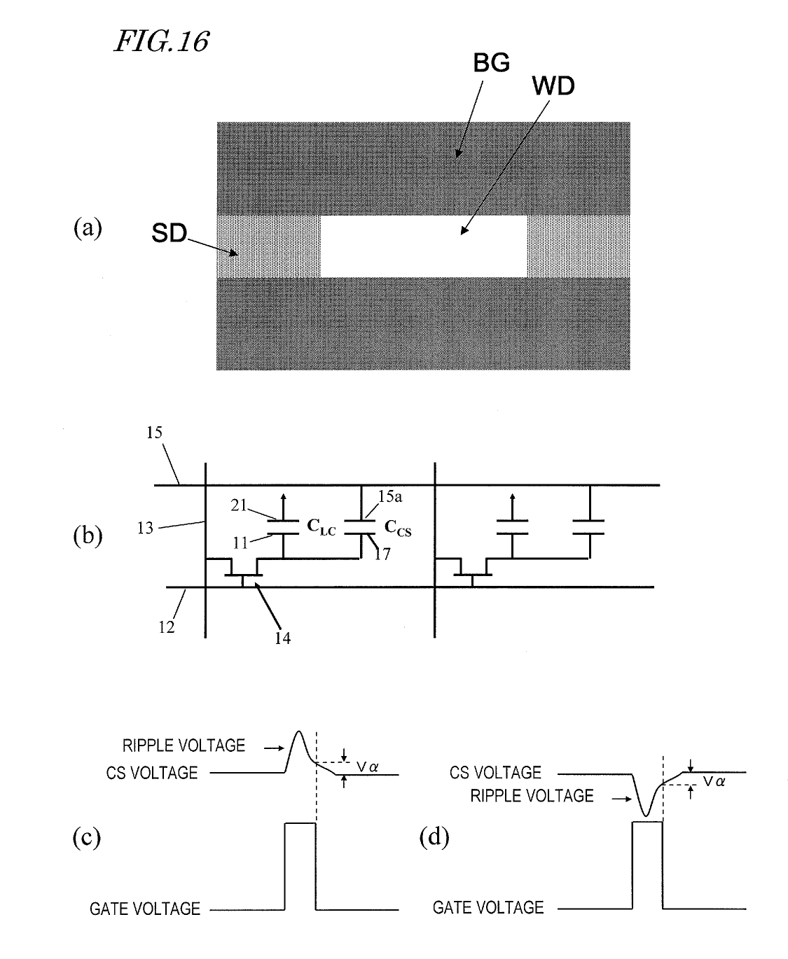

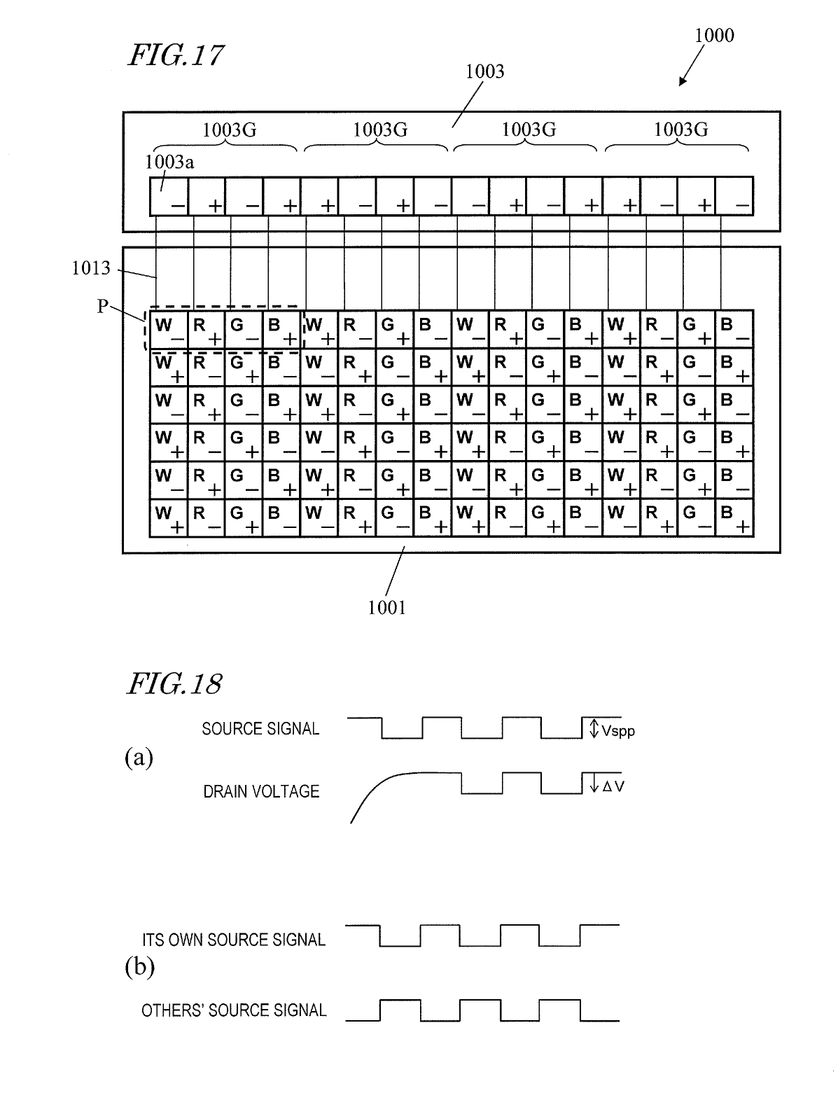

As for the respective kinds (i.e., the combination) of pixels that define a single picture element P, the combinations described above are just examples, too. For example, if each picture element P is defined by four kinds of pixels, each picture element P may be defined by either red, green, blue and cyan pixels R, G, B and C or red, green, blue and magenta pixels R, G, B and M. Alternatively, each picture element P may also be defined by red, green, blue and white pixels R, G, B and W as shown in FIG. 10. If the arrangement shown in FIG. 10 is adopted, a colorless and transparent color filter (i.e., a color filter that transmits white light) is arranged in a region of the color filter layer of the counter substrate 20 that is allocated to the white pixel W. With the arrangement shown in FIG. 10 adopted, the color reproduction range cannot be broadened because the primary color added is the color white, but the overall display luminance of a single picture element P can be increased.

Also, in the arrangements shown in FIGS. 1, 9 and 10, m different kinds of pixels are arranged in one row and m columns within each picture element P, and the color filters have a so-called “striped arrangement”. However, this is only an example of the present invention, too. Rather, those pixels may be arranged so that n out of the m kinds of pixels (where n is an even number that is equal to or smaller than m and is a divisor of m) are repeatedly arranged in the same order in the row direction. That is to say, in each picture element P, the m kinds of pixels may be arranged in (m/n) row(s) and n columns. Specifically, m=n may be satisfied as shown in FIG. 1, 9 and 10, or m≠n. For example, if each picture element P includes eight kinds of pixels, the eight kinds of pixels may be arranged in two rows and four columns in each picture element P.

### INDUSTRIAL APPLICABILITY

The present invention improves the display quality of a liquid crystal display device, of which each picture element is defined by an even number of pixels, and can be used effectively in a multi-primary-color liquid crystal display device.

### Reference Signs List

1 LCD panel
2 scan line driver (gate driver)
3 signal line driver (source driver)
3a output terminal
10 active-matrix substrate
10a, 20a transparent substrate
11 pixel electrode
12 scan line
12′ common scan line
13 signal line
13a first signal line
13b second signal line
14 thin-film transistor (TFT)
15 storage capacitor line
16 gate insulating film
18 interlayer insulating film
19, 29 alignment film
20 counter substrate
21 counter electrode
30 liquid crystal layer
100, 200 liquid crystal display device
P picture element
R red pixel
G green pixel
B blue pixel
Y yellow pixel
C cyan pixel
M magenta pixel
W white pixel

1. A liquid crystal display device having a plurality of pixels, which are arranged in columns and rows to form a matrix pattern, the device comprising:
an active-matrix substrate that includes pixel electrodes, each of which is provided for an associated one of the pixels, switching elements that are connected to the pixel electrodes, a plurality of scan lines that run in a row direction, and a plurality of signal lines that run in a column direction;
a counter substrate that faces the active-matrix substrate;
a liquid crystal layer that is interposed between the active-matrix substrate and the counter substrate;
a scan line driver that supplies a scan signal to each said scan line; and
a signal line driver that supplies a positive or negative grayscale voltage as a display signal to each said signal line,
wherein those pixels include m kinds of (where m is an even number that is equal to or greater than four) pixels that display mutually different colors, and
wherein the signal lines include multiple pairs of signal lines, each pair of signal lines being provided for an associated column of pixels, and
wherein each said pair of signal lines are first and second signal lines to which grayscale voltages of opposite polarities are supplied from the signal line driver, and
wherein in two of those pixels that are adjacent to each other in the column direction, the switching element of one of the two pixels is connected to the first signal line and the switching element of the other pixel is connected to the second signal line, and
wherein in two adjacent rows of pixels of those pixels, their switching elements have their ON and OFF states controlled using the same scan signal.

2. The liquid crystal display device of claim 1, wherein four of those signal lines, which are associated with two adjacent columns of pixels, are arranged so that the first signal line provided for one of two columns of pixels is adjacent to the second signal line provided for the other column of pixels.

3. The liquid crystal display device of claim 1, wherein four of those signal lines, which are associated with two adjacent columns of pixels, are arranged so that either the respective first signal lines or the respective second signal lines are adjacent to each other.

4. The liquid crystal display device of claim 1, wherein the pixels are arranged so that the m kinds of pixels are repeatedly arranged in the same order in the row direction.

5. The liquid crystal display device of claim 4, comprising a plurality of picture elements, each of which is defined by m pixels that are arranged consecutively in the row direction,
wherein in each of those picture elements, grayscale voltages of opposite polarities are applied to the pixel electrodes of two adjacent pixels, and
wherein in two arbitrary ones of those picture elements that are adjacent to each other in the row direction, grayscale voltages of mutually opposite polarities are applied to the pixel electrodes of pixels that display the same color.

6. The liquid crystal display device of claim 1, wherein the pixels include red, green and blue pixels representing the colors red, green and blue, respectively.

7. The liquid crystal display device of claim 6, wherein the pixels further include yellow pixels representing the color yellow.

8. The liquid crystal display device of claim 6, wherein the pixels further include white pixels representing the color white.

9. The liquid crystal display device of claim 6, wherein the pixels further include cyan, magenta and yellow pixels representing the colors cyan, magenta and yellow, respectively.

10. The liquid crystal display device of claim 1, wherein the device has a vertical scanning frequency of 120 Hz or more.
